(19) United States
(12) Patent Application Publication
(10) Pub. No.: US 2023/0286831 A1
(43) Pub. Date: Sep. 14, 2023

(54) Device and method for the production of a fertilizer and/or feed

(71) Applicant: TEC AUSTRIA GMBH, Salzburg (AT)

(72) Inventor: Michael KUHLWEIN, Salzburg-Aigen (AT)

(21) Appl. No.: 18/016,631

(22) PCT Filed: Jul. 16, 2021
(86) PCT No.: PCT/IB2021/056450

§ 371 Date: Jan. 17, 2023

(30) Foreign Application Priority Data
Jul. 17, 2020 (DE) 10 2020 119 041.7

(51) Int. Cl. C02F 1/04; C02F 11/13; C02F 1/32; C02F 1/00; B01D 1/00; B01D 17/02; B01D 5/00; B09B 3/40; A23K 10/00; F26B 3/24; F26B 11/16; F26B 21/08; C05F 7/00; C05F 17/40; C05F 17/60; C05F 17/70

(52) U.S. Cl. CPC C02F 1/048; C02F 11/13; C02F 1/32; C02F 1/008; C02F 1/001; B01D 1/0082; B01D 17/02; B01D 5/006; B09B 3/40; A23K 10/00; F26B 3/24; F26B 11/16; F26B 21/086; C05F 7/00; C05F 17/40; C05F 17/60; C05F 17/70; C02F 2103/32

(57) ABSTRACT

The disclosure relates to a device (21) for producing a fertilizer and/or feed, comprising a chamber (26) having a first opening (27) for letting in an emulsion (14′) of wastewater (8, 9) and grease (14), and a second opening (28) for adding organic waste (16), a circulating element (29) arranged in the chamber (26) for circulating a mixture (14′, 16) of the added emulsion (14′) and the added organic waste (16), and a heating element (30) for drying the mixture (14′, 16) by evaporating water (31) from the mixture (14′, 16).

### CROSS-REFERENCE TO RELATED APPLICATION

This application is a national stage application of PCT/IB2021/056450. This application claims priorities from PCT Application No. PCT/IB2021/056450, filed Jul. 16, 2021, and from the Germany patent application 10 2020 119 041.7 filed Jul. 17, 2020, the content of which is incorporated herein in the entirety by reference.

### TECHNICAL FIELD

The present disclosure relates to a device and method for the production of a dried product suitable as a fertilizer and/or feed.

### BACKGROUND

Organic waste, especially from the service sector for catering and/or hospitality, is currently transported away and incinerated in waste incineration plants or utilized in biogas plants. For the transport of 7.5 tons of organic waste, a corresponding truck emits carbon dioxide of about 52 kg, nitrogen oxides of about 1.5 kg, sulfur dioxides of about 82 g and particulate matter of about 20 g on a distance of 100 km at an average speed of 60 km/h, and consumes 20 liters of diesel. In addition to these climatic aspects, there is also the necessary economic expense of transport.

Therefore, it is the object of the disclosure to improve the disposal of organic waste, especially in the service sector for catering and/or hospitality.

### SUMMARY

The task is fulfilled by the characteristics of the independent claims. Preferred embodiments are the subject matter of the dependent claims.

According to one aspect of the disclosure, a device for producing a fertilizer and/or feed comprises a chamber having a first opening for letting in an emulsion of wastewater and grease and a second opening for adding organic waste, a circulating element arranged in the chamber for circulating a mixture of the added emulsion and the added organic waste, and a heating element for drying the mixture by evaporating water from the mixture.

The specified device is based on the idea that organic waste could actually be recycled as animal feed or as fertilizer. From this thought it is the idea of the specified device not to dispose of organic wastes any more, but to convert them locally into a saleable product in the form of a fertilizer and/or feed. The production of one ton of artificial fertilizer requires 2,000 l of heavy oil and an energy input of 22,000 kWh. In contrast, one ton of fertilizer can already be achieved with the specified device with an energy input of 4,000 kWh from a pure waste product. Therefore, in addition to environmental protection, the costs of a service company for the catering and/or hospitality can also be reduced with the specified device because, in addition to the omitted removal of the organic waste, a saleable product is obtained directly.

In one embodiment, the specified device comprises a condenser for condensing the evaporated water and for discharging the condensed water into a collecting tank. The water from this collecting tank can be used for garden irrigation, for example, and need not, in principle, be disposed of. Thus, the operating costs of a service company for catering and/or hospitality of guests can be further reduced because fewer costs incur for wastewater disposal.

In an additional embodiment of the specified device, the collecting tank contains means for sterilizing the condensed water. In this way, the range of use of the condensed water can be further increased, because it reaches the quality of service water, if not even of drinking water. Service water, also known as process water or industrial water, shall be understood in the following as water free of germs and bacteria. In contrast, drinking water is a fixed term and meets relevant water quality standards such as DIN2000.

In a particular embodiment, the collecting tank of the specified device comprises a connection for tapping the condensed water as service and/or drinking water, so that the condensed water can be used, for example, to operate a toilet flushing system or for laundry cleaning. Thus, the operating costs of a service company for catering and/or hospitality can be further reduced because water for operating certain equipment within the service company no longer needs to be purchased externally.

In another embodiment, the specified device comprises a humidity sensor for sensing a level of humidity in the chamber and a controller for turning off the heating element in response to the sensed level of humidity. In this way, unnecessary energy costs for operating the specified device can be avoided.

In another embodiment, the specified device comprises another chamber with a filter for pre-filtering water from the emulsion. Pre-filtering allows the water content of the emulsion to be reduced in advance, so that a lower energy input is required to dry the entire mixture.

In a particular embodiment of the specified device, the filter comprises a ceramic membrane which can reliably separate the water from the emulsion in a cost-effective manner.

In this case, the filtered water can be directed into the above-mentioned collecting tank and processed into drinking or service water.

In a further embodiment of the specified device, the circulating element is a stirring unit which can reliably circulate the mixture with a sufficiently high input of force.

According to a further aspect of the disclosure, a method of controlling one of the specified devices after the device is charged with organic waste comprises the following steps:
controlling a first closure element closing the first opening to let the emulsion in, and
switching on the heating element when the chamber is charged with the emulsion to a certain degree.

In accordance with another aspect of the disclosure, a control device is provided for carrying out the aforementioned method.

In a further embodiment, the cited device has a memory and a processor. The cited method is saved in the memory in the form of a computer program, and the processor is provided for executing the method when the computer program is loaded from the memory into the processor.

According to another aspect of the disclosure, a computer program comprises program code resources for executing all the steps of the stated method when the computer program is executed on an electronic device or one of the specified devices.

According to another aspect of the disclosure, a computer program product contains a program code which is saved on a computer-readable data carrier, and which carries out the stated method when it is executed on a data processing device.

In accordance with a further aspect of the disclosure, a method to produce a fertilizer and/or feed comprises the steps:
charging a chamber with a mixture comprising an emulsion of wastewater and grease and organic waste, and
drying the mixture by evaporating water from the mixture while circulating the mixture.

### BRIEF DESCRIPTION OF THE DRAWINGS

The above-described properties, features and advantages of this disclosure, as well as the manner in which they are achieved, will become clearer in connection with the following description of the embodiments, which are explained in more detail in connection with the drawing, in which:

FIG. 1 is a structural diagram to visualize organic waste disposal in a service company for catering and/or hospitality,

FIG. 2 is a structural diagram to visualize an alternative organic waste disposal in a service company for catering and/or hospitality,

FIG. 3 is a structural diagram of a device for producing a fertilizer and/or feed from organic waste in a first operating condition, and

FIG. 4 is a structural diagram of a device for producing a fertilizer and/or feed from organic waste in a second operating condition.

### DETAILED DESCRIPTION

In the drawings, the same technical elements are provided with the same reference signs, and are only described once. The drawings are purely schematic and, in particular, do not reflect the actual geometric proportions.

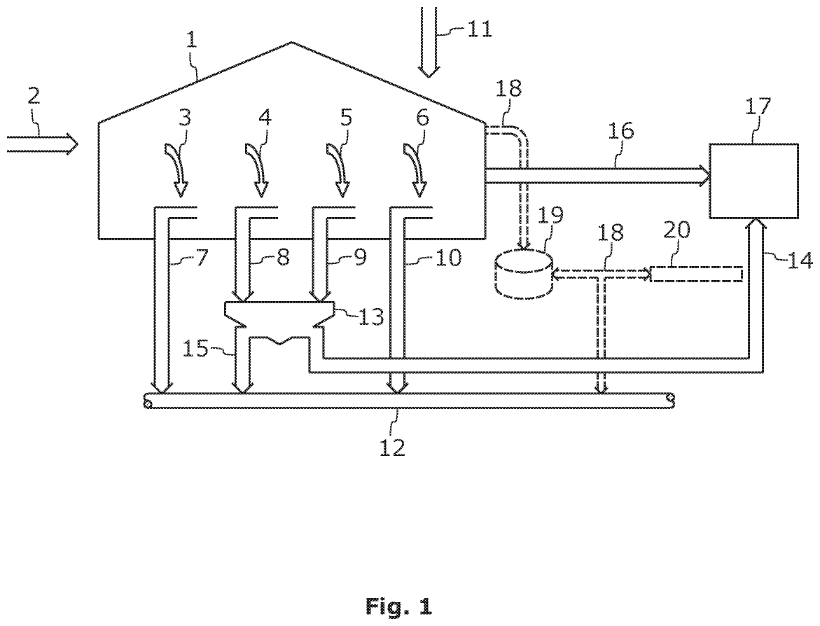

Reference is made to FIG. 1, which is a structural diagram to visualize organic waste disposal in a service company 1 for catering and/or hospitality. Such a service company 1 may be, for example, a restaurant or a hotel.

The service company 1 uses potable water 2 provided through a fresh water connection not shown in any further detail for the operation of sanitary facilities 3, kitchen equipment 4 not shown further, for cleaning 5 of the premises, and other purposes 6. Accordingly, sanitary wastewater 7, kitchen wastewater 8, cleaning wastewater 9 and other wastewater 10 are generated. In addition, rainwater 11 is also collected.

The sanitary water 7 and the other wastewater 10 can usually be discharged directly into a sewer system 12. However, the kitchen wastewater 8 and the cleaning wastewater 9 may be very greasy, depending on the type of service company 1. Depending on local legislation, relatively strict limits may be prescribed for the discharge of grease in kitchen wastewater 8 and in cleaning wastewater 9 into the sewer system 12 by the service company 1, i.e. for the so-called indirect discharge of grease, which can only be complied with by installing a grease separator 13. The grease separator 13 separates grease 14 from the kitchen wastewater 8 and the cleaning wastewater 9, and discharges the remaining residual water 15 into the sewer system 12.

The grease 14 from the kitchen wastewater 8 and the cleaning wastewater 9 can be stored together with other organic waste 16 in a suitable waste container 17 until it is transported to a waste incineration plant or a biogas plant.

The rainwater 11 is usually collected in a rain gutter 18, temporarily stored in a tank 19, and percolated on a seepage surface 20, for example in a garden. If the seepage surface 20 is not sufficient or not available at all, the rainwater 11 can also be discharged into the sewer system 12 directly or temporarily stored via the tank 19.

An average service company 1 in the form of a restaurant from the system catering sector is supplied with an annual drinking water volume of 1,650 m³. While a quantity of 750 m³ is produced annually as sanitary water 7 in the average company, the remaining wastewater 8, 9 and 10 adds up to an annual quantity of 900 m³. The annual amount of rainwater 11 depends on the location. In Central Europe, an annual quantity of 700 m³ is realistic. The grease separator 13 separates a quantity of 36 m³ of grease 14 from the kitchen wastewater 8 and the cleaning wastewater 9 per year in the average system gastronomy restaurant. In addition, 18 to 20 tons of organic waste 16 are generated.

For the provision of drinking water 2 and the associated disposal of wastewater, the average system gastronomy restaurant has to calculate a price of 5.30 euros per liter, and thus total annual costs of 8,745 euros. This calculation does not include ancillary costs such as sewer fees and the like. For the pure operation of a grease separator 13, the average restaurant from the system catering industry generates annual analysis costs of 300 euros, maintenance costs of 435 euros and general inspection costs of 155 euros. For new systems, there are additional acquisition costs of 50,000 euros, which can be depreciated over a period of 5 to 6 years. For the disposal of the grease 14 and the organic waste 16, annual costs of 6,126 euros result, whereby the personnel involved in the disposal still has to be considered at 5,000 euros per year.

The costs for water and organic waste disposal in the average system gastronomy restaurant therefore amount to an estimated total annual amount of approximately 21,000 euros. This amount does not take into account the cost of rainwater disposal if no or insufficient seepage areas 20 are available.

In the following it will be described how these costs can not only be reduced, but how the grease 14 and the organic waste 16 can also be recycled economically.

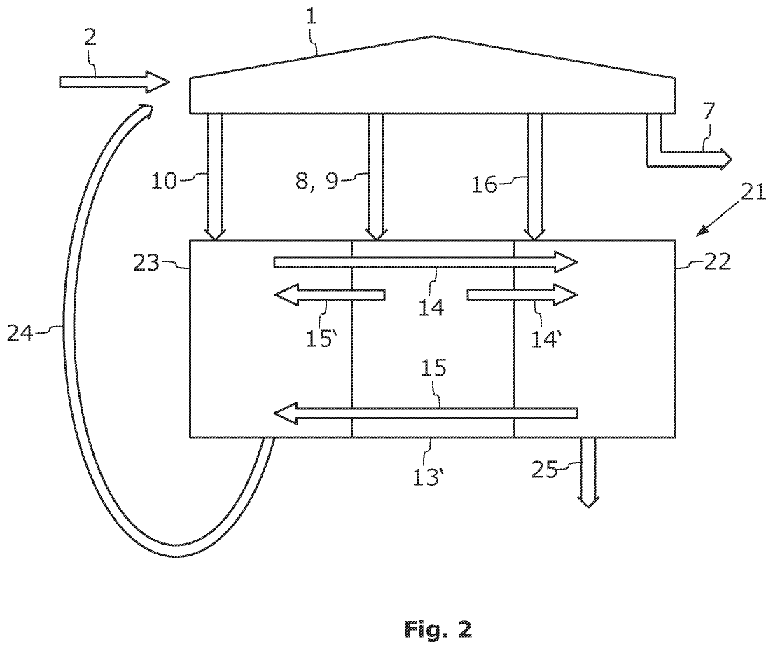

For this purpose, reference is made to FIG. 2, which shows a structural diagram visualizing an alternative organic waste disposal 1 in the service company 1 of FIG. 1.

The wastewaters 7, 8, 9 and 10 of FIG. 1 are also included in the structural diagram of FIG. 2. For the sake of simplicity, the rainwater 11 is not taken into account, but it can also be integrated into the idea without further problems.

For the disposal of the organic waste 16 and the grease 14, a device 21 with a drying device 22, a separating device 13′ and a processing device 23 is provided in the service company 1.

The task of the separating device 13′ is basically the same as that of the grease separator 13; it is to separate the grease 14 and the residual water 15 from each other in the kitchen wastewater 8 and the cleaning wastewater 9, whereby the grease 14 is fed to the drying device 22 and the residual water 15 to the treatment device 23. However, the separation of the grease 14 from the residual water 15 is not necessary for the operation of the drying device 22. In principle, the drying device 22 also functions if the kitchen wastewater 8 and the cleaning wastewater 9 are simply fed into the drying device 22 without being separated. The separating device 13′ merely increases the efficiency of the drying device 22, and can be of any high or low quality. For this reason, the long arrows in FIG. 2 between the three devices 13′, 22 and 23 indicate the basic path of separation of the grease 14 and the residual water 15. In contrast, a short arrow 14′ from the separating device 13′ to the drying device 22 indicates an emulsion of water and grease 14 in which predominantly the grease 14 is present, while a short arrow 15′ from the separating device 13′ to the processing device 23 indicates a residual liquid in which, however, portions of the grease 14 may still be present.

The treatment device 23 is basically optional. The liquids 10 and 15′ taken up by it could, in principle, also be discharged into the sewer system 12. However, if the received liquids 10 and 15′ are treated by sterilization or the like and freed from impurities, the treated liquids can be reused by the service company 1 at least as service water 24, for example for operating the sanitary facilities 3. Depending on the quality of the treatment equipment 23, reuse also as drinking water is conceivable. The only wastewater to be disposed of would then be that which can no longer be recycled at an economically reasonable cost, such as sanitary wastewater 7.

The drying device 22 receives the emulsion 14′ with the grease 14, and is also fed with the organic waste 16. In a manner to be described in detail later, the drying device 22 has a circulating element for circulating the mixture of the emulsion 14′ and the organic waste 16 and a heating element for drying the mixture 14′, 16.

With the drying of the mixture 14′, 16, water is extracted from it. The product 25 dried by water removal is preservable so that it can be transported and reused elsewhere, for example for animal feed or fertilization. In this way, neither the organic waste 16 nor the grease 14 needs to be disposed of, but can rather be resold at an economic profit.

The above-mentioned average service company 1 in the form of the system gastronomy restaurant, which has an annual drinking water requirement of 1,650 m³, can use the system of FIG. 2 to operate at least the sanitary facilities 3 on a self-sufficient basis, whereby the water consumption can be reduced to 900 m³ per year. As a result, the annual water consumption costs can be reduced to 4,770 euros. For the sake of simplicity, the operating costs for the grease separator 13′ can be taken as the operating costs for the separator 13. However, the disposal costs for the organic waste 16 and the grease 14 amounting to 6,126 euros do not incur. Instead, the dried product 25 can be sold as a useful product, for example in agriculture as fertilizer or feed, at a market price of approximately 1,850 euros per year. However, this turnover is offset by annual energy costs of approximately 1,665 euros. Because the disposal of the organic waste 16 and the grease 14 is completely eliminated, only half the amount of work is required, so that the personnel costs also fall to 2,500 euros per year.

In total, the system according to FIG. 2 costs the service company 1 in the form of the system gastronomy restaurant only 8,000 euros per year, so that with the system according to FIG. 2 the operating costs for the disposal of organic waste 16 and grease 14 can be reduced to one third.

Beyond these purely economic considerations that instead of landfilling or disposing, products are generated, the system according to FIG. 2 can also halve the consumption of drinking water, which is a clear advantage especially in regions with less water. Furthermore, odor nuisance caused by food residues and vermin attracted by food residues are reduced. The system also noticeably simplifies logistics because there is no longer any need to pick up garbage cans, pump out grease traps or the like. The system shown in FIG. 2 also has a high degree of automation and can therefore be kept very simple to operate and requires a reduced number of personnel. The system according to FIG. 2 can be kept absolutely sterile by drying out the organic waste 16 and the grease 14 by means of heat, because any desired temperature treatment of well over 180° C. can be set.

In new plants, it is no longer necessary to install a grease separator 13. Instead, any other systems that are significantly less expensive and also easier to maintain can be used as separators 13′.

From an environmental point of view, the system shown in FIG. 2 reduces the CO₂ footprint because the almost completely dried-out product 25 means that hardly any moisture has to be transported. Transport costs can be reduced by up to 95%. Waste incineration or other landfilling is completely eliminated and also no longer causes any greenhouse gases.

Finally, the system according to FIG. 2 also reduces the need for artificially produced fertilizer.

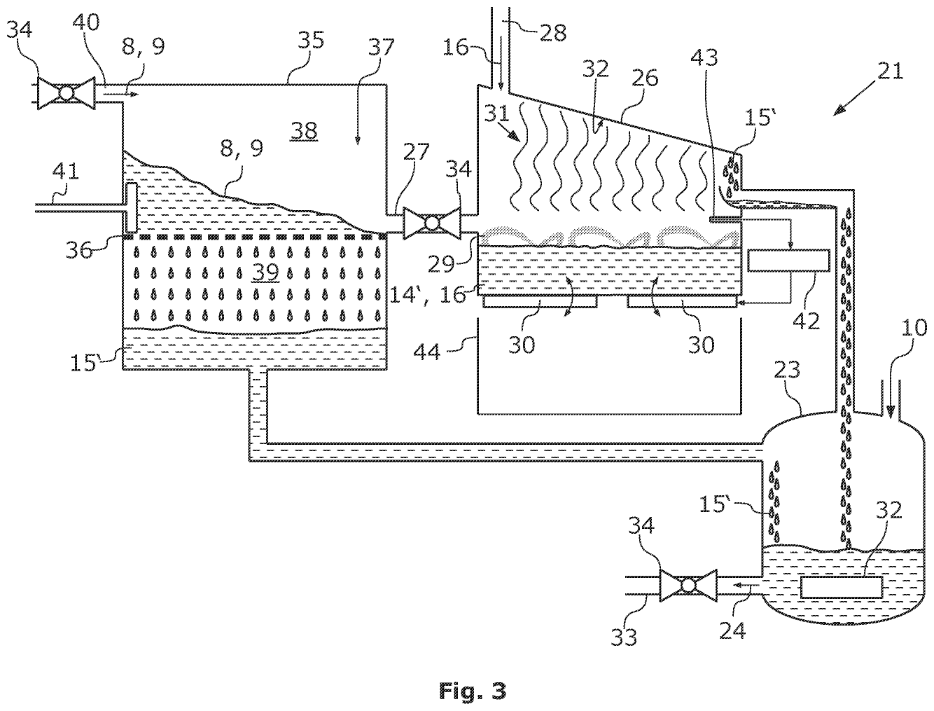

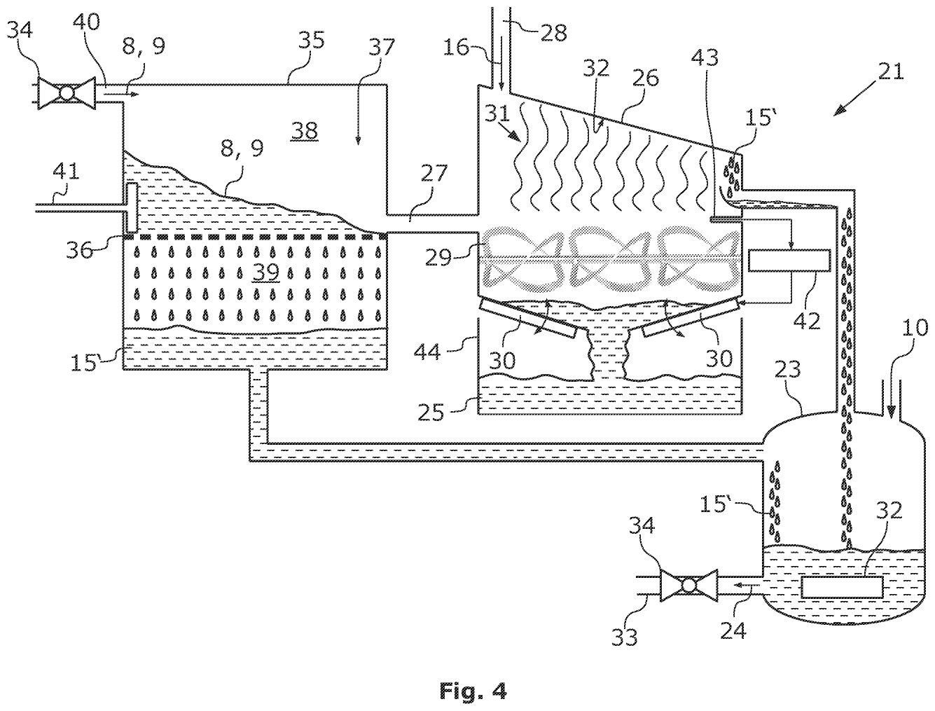

Now that the idea has been described structurally with reference to FIG. 2, FIGS. 3 and 4 will be used to describe a specific example of the device 21 that can be used to produce the dried product 25 from the organic waste 16 and the grease 14 for use as fertilizer or animal feed.

The core of the device 21 is a chamber 26 into which the emulsion 14′ of water and grease 14 can be introduced via a first opening 27. The organic waste 16 can be introduced into the chamber 26 via a second opening 28.

A circulating element, here in the form of a stirring unit 29, is arranged in the chamber 26. The stirring unit 29 mixes the emulsion 14′ with the organic waste 16 and continuously circulates it.

Heating elements 30 are located at the bottom of chamber 26 which heat the mixture of emulsion 14′ and organic waste 16 circulated by the stirring unit 29. The heating temperature is selected such that water evaporates from the mixture of emulsion 14′ and organic waste 16 and the mixture 14′, 16 is thus dried. In a particularly favorable manner, the heating temperature can be selected such that a sterilization effect is achieved and the mixture of emulsion 14′ and organic waste 16 is simultaneously freed from germs and bacteria during drying.

The water 31 evaporated from the mixture 14′, 16 can, in principle, be discharged into the environment via any fume hood. In order to reduce water costs and to reuse the evaporated water 31 as liquid 15′, for example for the sanitary facilities 3, the chamber 26 can be closed with a ceiling wall 32 serving as a condenser, on which the evaporated water 31 condenses to liquid 15′ and is discharged into a collecting tank which also serves as a treatment device 23. For this purpose, means for sterilization 32 are provided in the treatment device 23, which can sterilize the liquid 15′, for example by means of UV irradiation. Furthermore, an outlet 33 can be provided at the treatment device 23, via which the sterilized liquid 15′ can be tapped off as service water 24 in a controlled manner via a tap 34.

Upstream of the chamber 26 is a further chamber 35, the two chambers 26, 35 being connected to one another via the first opening 27. In the further chamber 35, a filter 36 is arranged here in the form of a ceramic membrane, which, viewed in a downward direction 37, separates chamber 35 into an upper part 38 and a lower part 39.

Via a feed opening 40, the upper part 38 of the further chamber 35 can be fed with kitchen wastewater 8 and cleaning wastewater 9, which then falls onto the filter 36. There, the liquid 15′ passes through the filter 36 and falls into the lower part 39 of the further chamber 35.

The emulsion 14′ with the grease 14 remains on the filter 36. The emulsion 14′ can now enter the chamber 26 via the first opening 27. If the emulsion 14′ is not fluid enough, it can also be pushed into the chamber 26 by a means of conveyance such as a slide 41.

In the lower part 39 of the further chamber 35, the liquid 15′ that has passed through the filter 36 can be collected and also introduced into the treatment device 23 via a connection that is not further referenced. There it is then further processed in the same way as the liquid 15′ obtained from the condensed water 31.

Finally, the other wastewater 10 can still be fed directly into the treatment device 23.

In the operation of the device 21, the kitchen wastewater 8 and the cleaning wastewater 9 are first introduced into the further chamber 35. There, the emulsion 14′ is obtained by filtering off liquid 15 and is fed into chamber 26. In the chamber 26, the emulsion 14′ is heated together with organic waste 16 added to the chamber 26 and circulated by means of the stirring unit 29. A control device 42 detects the humidity content in the chamber 26 via a humidity sensor 43. If the humidity content in the chamber 26 falls below a predetermined level, the control device 42 turns off the heating elements 30 and opens a bottom of the chamber 26 so that the dried product 25 can fall into a collecting tank 44 below the chamber 26.

Although the drying process has previously been described as being carried out by machine, in principle the process can also be carried out manually. The implementation of this process only requires a suitable vessel, a heat source which heats the vessel, and suitable circulating tools.

However, the great advantage of the device 21 is that basically all steps can be automated and initiated by the control device 42. Thus, the control device 42 can control suitable valves, such as the taps 34, to feed the chambers 26, 35 with the respective wastewaters 7, 8, 9 and 10. The control device 42 may also turn on and off the stirring unit 29 and the heating elements 30, and open the bottom of the chamber 26 for unloading the dried product.

1. A device (21) for producing a fertilizer and/or feed comprising a chamber (26) having a first opening (27) for letting in an emulsion (14′) of wastewater (8, 9) and grease (14), and a second opening (28) for adding organic waste (16), a circulating element (29) arranged in the chamber (26) for circulating a mixture (14′, 16) of the added emulsion (14′) and the added organic waste (16), and a heating element (30) for drying the mixture (14′, 16) by evaporating water (31) from the mixture (14′, 16).

2. The device (21) according to claim 1, comprising a condenser (32) for condensing the evaporated water (31) and for discharging the condensed water (15′) into a collecting tank (23).

3. The device (21) according to claim 2, wherein said collecting tank (23) includes means for sterilizing (32) said condensed water (15′).

4. The device (21) according to claim 2, wherein the collecting tank (23) comprises a connection (33) for tapping the condensed water (31) as service water (24) and/or drinking water (2).

5. The device (21) according to claim 1, further comprising a humidity sensor (43) for sensing a level of humidity in the chamber (26), and a controller (42) for turning off the heating element (30) in response to the sensed level of humidity.

6. The device (21) according to claim 1, further comprising another chamber (35) with a filter (36) for pre-filtering water (15′) from the emulsion (14′).

7. The device (21) according to claim 6, wherein the filtered water (15′) is directed into the collecting tank (23).

8. A method for controlling the device (21) according to claim 1 after the device (21) is fed with organic waste (28), comprising:
controlling a first closure element (34) closing the first opening (27) to let the emulsion (14′) in, and
switching on the heating element (30) when the chamber (26) is charged with the emulsion (14′) to a certain degree.

9. A control device (42) for performing the method according to claim 8.

10. A method for production of a fertilizer and/or feed, comprising:
charging a chamber (26) with a mixture (14′, 16) comprising an emulsion (14′) of wastewater (7, 8) and grease (14) and organic waste (16), and
drying the mixture (14′, 16) by evaporating water (31) from the mixture (14′, 16) while circulating the mixture (14′, 16).

11. The device (21) according to claim 3, wherein the collecting tank (23) comprises a connection (33) for tapping the condensed water (31) as service water (24) and/or drinking water (2).

12. The device (21) according to claim 2, further comprising a humidity sensor (43) for sensing a level of humidity in the chamber (26), and a controller (42) for turning off the heating element (30) in response to the sensed level of humidity.

13. The device (21) according to claim 3, further comprising a humidity sensor (43) for sensing a level of humidity in the chamber (26), and a controller (42) for turning off the heating element (30) in response to the sensed level of humidity.

14. The device (21) according to claim 4, further comprising a humidity sensor (43) for sensing a level of humidity in the chamber (26), and a controller (42) for turning off the heating element (30) in response to the sensed level of humidity.

15. The device (21) according to claim 2, further comprising another chamber (35) with a filter (36) for pre-filtering water (15′) from the emulsion (14′).

16. The device (21) according to claim 3, further comprising another chamber (35) with a filter (36) for pre-filtering water (15′) from the emulsion (14′).

17. The device (21) according to claim 4, further comprising another chamber (35) with a filter (36) for pre-filtering water (15′) from the emulsion (14′).

18. The device (21) according to claim 5, further comprising another chamber (35) with a filter (36) for pre-filtering water (15′) from the emulsion (14′).

19. The method according to claim 8, comprising a condenser (32) for condensing the evaporated water (31) and for discharging the condensed water (15′) into a collecting tank (23).

20. The method according to claim 19, wherein said collecting tank (23) includes means for sterilizing (32) said condensed water (15′).
